(19) United States
(12) Patent Application Publication
(10) Pub. No.: US 2007/0000625 A1
(43) Pub. Date: Jan. 4, 2007

(54) Window shade for motor vehicles with positive end stop on the actuating element

(75) Inventors: Olaf Buhl, Albershausen (DE); Harry Weinbrenner, Ostfildern (DE); Melf Hansen, Gondelsheim (DE); Matthias Maier, Esslingen (DE); Herbert Walter, Ebersbach (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: BOS GmbH & Co. KG, Ostfildern (DE)

(21) Appl. No.: 11/450,705

(22) Filed: Jun. 9, 2006

(30) Foreign Application Priority Data
Jun. 29, 2005 (DE) 10/2005 030707.8

(51) Int. Cl. B60J 1/20

(52) U.S. Cl. 160/370.22

(57) ABSTRACT

A roller blind for motor vehicles in which pulling out movement of the sheet like window shade is effected by means of motor powered thrust elements. In order to limit the movement of the thrust element in an end position if the driving motor remains switched on, an end stop element seated on at least one of the thrust elements comes into contact with a stationary end stop and blocks additional movement.

### FIELD OF THE INVENTION

This present invention relates generally to window shades, and more particularly, to power operated window shades for motor vehicles.

### BACKGROUND OF THE INVENTION

DE 103 39 583 describes a roller blind for a rear window of motor vehicles with a winding shaft that is rotatably supported beneath the rear window shelf. One edge of a sheet-like shade is fixed to the winding shaft. The other edge of the sheet-like shade that extends parallel to the aforementioned edge is anchored in a pull-out rod, the ends of which are guided for movement in guide rails. The guide rails are integrated into the interior lining of the motor vehicle and consist of plastic.

The roller blind is pulled out with the aid of thrust elements that are guided in the guide rails. Each thrust element is in the form of a flexible rack with circumferential gearing. Each of the thrust elements meshes with an output gear of a gear motor such that a positive drive is effected.

The cost of such motor vehicle accessories has dropped significantly. For this reason the control for the drive motor also must be made as simple as possible. In this respect, it is common practice to control pull out movement of the roller blind by means of a central control for the motor vehicle, i.e., by supplying the motor with current for a period of time that exceeds the expected maximum pull-out time. The pulling movement is limited in that the pull-out rod comes into contact with a positive end stop in the guide rail. However, this arrangement can lead to over stressing problems if the guide rails are made of plastic.

### OBJECTS AND SUMMARY OF THE INVENTION

It is an object of the present invention to provide a roller blind for motor vehicles in which no additional forces occur in the guide rail when the pull rod reaches a pulled out end position.

Another object is to provide a roller blind as characterized above which is adapted for reliable operation even when the guide rails of the roller blind are inexpensively made of plastic.

The roller blind of the invention utilizes a conventional rotatably supported winding shaft. A sheet-like shade extending between the winding shaft and the pull-out rod is fixed on the winding shaft, and the pull-out rod fixed to the other end of the slide is guided for movement in guide rails on at least one end, and preferably both ends. A spring motor is coupled to the winding shaft in order to ensure that the sheet-like shade remains under tension. This spring motor further serves to wind the sheet-like shade on the winding shaft when the linear thrust elements are retracted.

The thrust elements are driven by a gear motor, the output gear of which positively meshes with the thrust elements. Consequently, the driving gear divides each thrust element into a working section and an idle section, wherein the working section lies between the driving gear and the pull-out rod and the remainder of the thrust element forms the idle section. The length of the working section varies between a minimum value when the shade is in the retracted state and a maximum value when the shade is in an extended position.

Pursuant to an important feature of the invention, an end stop is arranged on the idle section of at least one thrust element in order to limit the maximum travel of the thrust element when the driving motor remains switched on for an arbitrary period of time. The end stop cooperates with a complementary end stop on the gear motor. This causes the idle section to be subjected to tension in the region between the end stop and the gear. Therefore, the thrust element must have a corresponding tensile strength in this region.

When the end stop comes into contact with the other end stop, the movement is definitively stopped and the motor is blocked. This blocking of the motor takes place without any additional forces that exceed the normal forces occurring in the guide rails or the connecting tubes that connect the guide rails to the gear motor.

The stationary end stop may either consist of the gear housing of the motor or a corresponding end stop that is stationarily arranged in some other way. The utilization of the gear housing for the stationary end stop is preferred because it is the simplest solution.

Various alternatives may be used for the end stop on the idle section. The end stop may be in the form of a simple sleeve that is twisted with the thrust element or in the form of a hollow rivet with a flanged surface for enlarging the stopping surface.

It will be understood that the invention can be utilized in connection with any type of roller blind in motor vehicles in which the drive is carried out with the aid of positively driven thrust elements. This includes, in particular, side windows, moonroofs and cargo area covers.

Other objects and advantages of the invention will become apparent upon reading the following detailed description and upon reference to the drawings, in which:

### BRIEF DESCRIPTION OF THE SEVERAL VIEWS OF THE DRAWING(S)

FIG. 1 is a broken open perspective of a rear area of a motor vehicle having a window roller shade in accordance with the invention;

FIG. 2 is a schematic depiction of the window roller shade of the present invention shown in an extended position; and

FIG. 3 is a fragmentary section of the stop arrangement for automatically limiting pull-out travel of the roller blind.

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DETAILED DESCRIPTION OF THE INVENTION

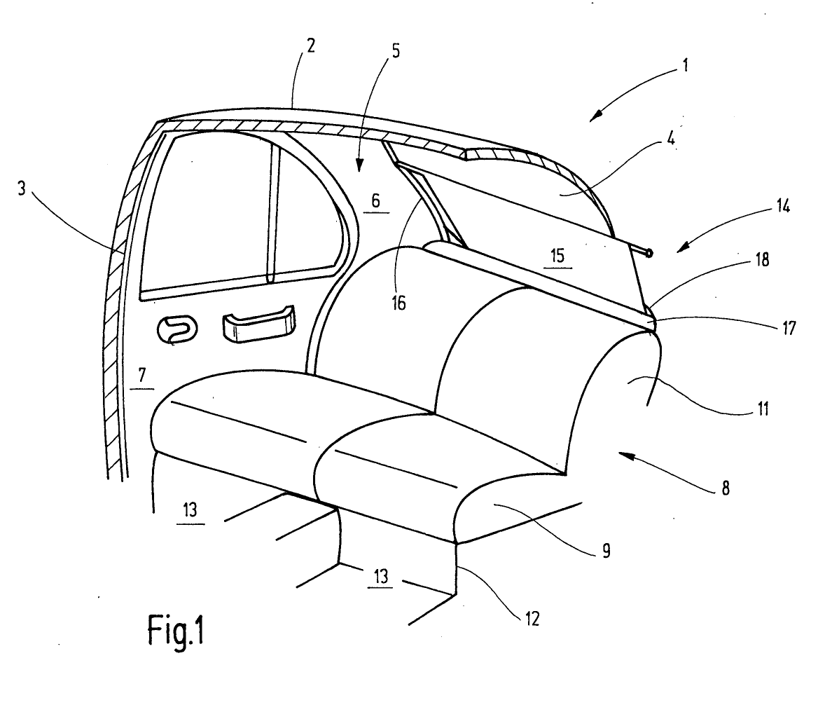

Referring now more particularly to FIG. 1 of the drawings, there is shown an illustrative motor vehicle having a side window roller blind assembly in accordance with the invention. FIG. 1 represents a cut-away rear area of a passenger car. The figure illustrates a view towards the right-side interior, which is the mirror image of the not-shown left-side interior. The view is simplified; for example, car body interior structures such as braces and attachment means are not shown because their illustration is not necessary for understanding the invention.

The illustrated car body section 1 has a roof 2 from which a B-column 3 extends downwardly at the side to a an underbody. A corresponding B-column is provided on the opposite side of the vehicle. The roof 2 transitions at its rear edge into a rear window 4. At the side, the rear window 4 ends at a C-column 5 located at a distance from the B-column 3. The C-column 5 carries an interior lining 6.

Between the B-column and the C-column, a rear right side door 7 is hinged in a known way to the B-column. At the height of the right rear side door 7 there is a rear seat bench 8 which includes a sitting surface 9 and also a rear seat back 11. The rear seat back 9 is supported on a base surface 12 that is part of the underbody in front of which are foot spaces 13. At the height of the top edge of the rear seat back 11, a rear seat shelf 17 extends to the bottom edge of the rear window 4.

A roller blind for a rear window 14 is arranged on the inner side of the rear window 4, which is shown in FIG. 1 with a sheet-like shade 15 thereof in a partially extended position. Opposed guide rails 16 guide movement of the roller blind. The guide rails 16 begin at the rear window shelf 17 located behind the rear seat back 11 and extend adjacent to the side edges of the window. Each guide rail made of plastic and is integrated into the interior lining of the C-column 5. The rear window shelf 17 also has a continuous pull-out slot 18, through which the sheet-like shade 15 is pulled out.

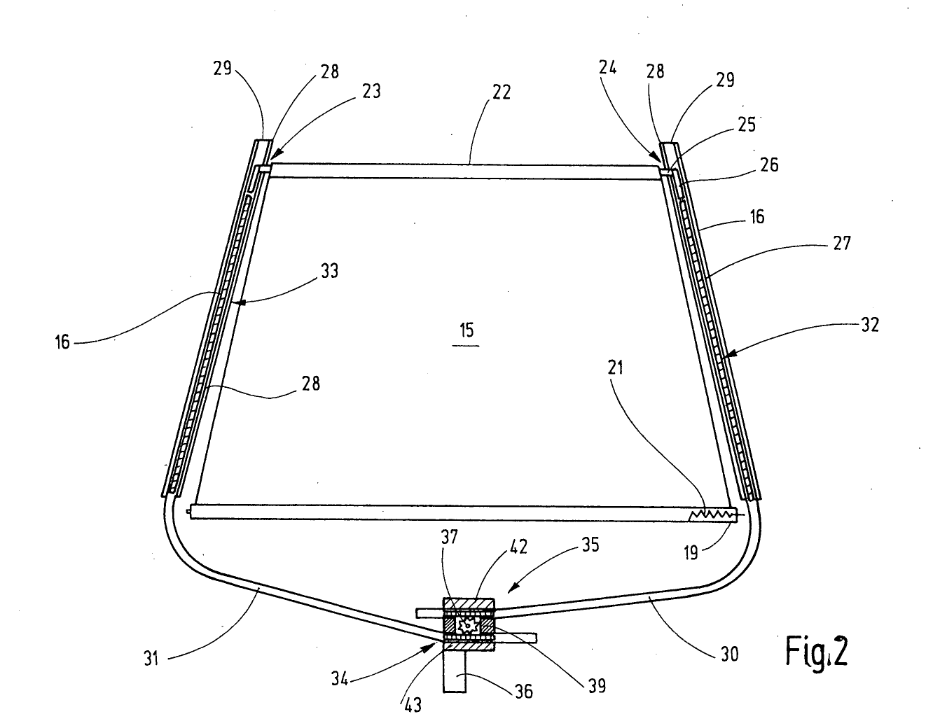

The roller blind for a rear window 14, as depicted in FIG. 2, includes a rotatably supported winding shaft 19 that extends underneath the rear window shelf 17, with one edge of the sheet-like shade 15 being fixed to the winding shaft. The winding shaft 19 is prestressed in the wind-up direction of the sheet-like shade 15 on the winding shaft 19 by a spring motor 21. This spring motor in this instance is in the form of a coil spring that is rigidly anchored on the car body at one end and fixed in the winding shaft 19 at the other end.

The sheet-like shade 15 is cut into an approximately trapezoidal shape and provided with a tubular loop on its distant edge relative to the winding shaft 19. A pull-out rod or crossbar 22 with guide pieces 23, 24 telescopically supported therein extends through the tubular loop. The guide pieces 23, 24 each has a neck section 25 that has a smaller diameter than an adjacent guide element 26. The guide element in this case is in the form of a short cylindrical section.

The guide pieces 26 move in guide rails 17 that are arranged as mirror images adjacent to the two lateral edges of the rear window 4. Each guide rail 16 defines a guide groove 27, the cross-sectional profile of which is composed of a groove slot 28 and a groove chamber 29. The diameter of the groove chamber 29 corresponds to the guide element 26 while the width of the groove slot 28 is smaller than the diameter of the circular groove chamber 29, but sufficiently wide for accommodating the neck section 25.

The lower end of each of guide rail 16 is connected to a guide tube 30, 31. A flexible, compression resistant thrust element 32, 33 is respectively guided in each guide tube 30, 31 for movement forwardly into the groove chamber 29 of the respective guide rail 16.

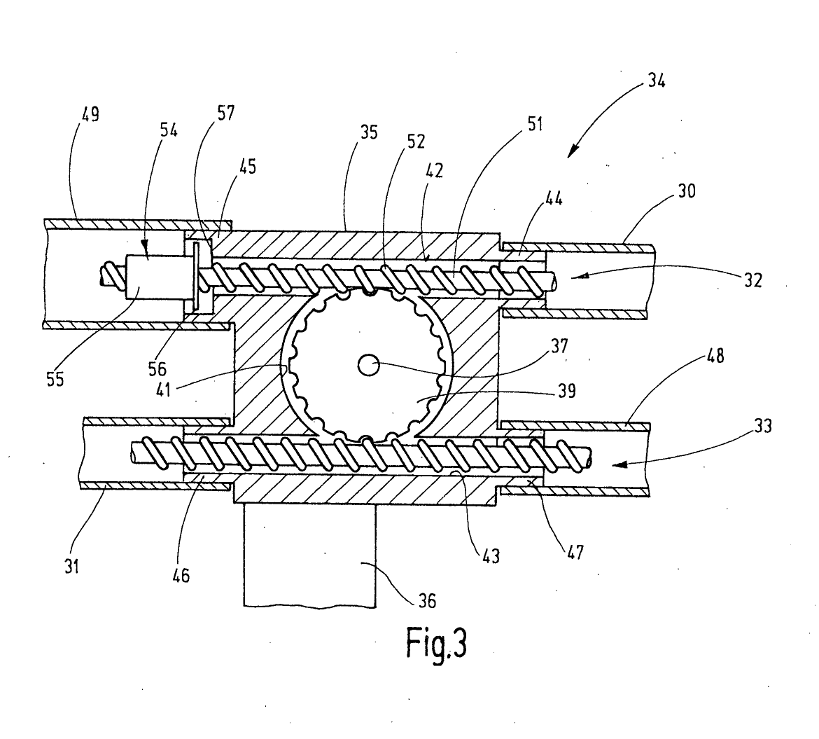

For driving the thrust elements 32,33, a gear motor 34 with a gear housing 35 is located on the distant end of the guide tubes 30, 31 relative to the guide rails 16. As depicted in FIG. 3, the motor in this case is a permanent-magnet DC motor 36 which is flanged to the gear housing 35 and drives an output shaft 37 via an appropriate cylindrical gear or a worm gear pair. An output gear 39 arranged in a hollow space 41 of the gear housing is seated on the output shaft 37 without rotational play. The hollow space 41 has an approximately cylindrical shape.

Two straight through-holes 42, 43 extend through the gear housing 35 tangentially to the hollow space 41. Tubular connection pieces 44, 45, 46 and 47 are aligned with and are continuous with the two through-holes 41, 43. The guide tube 30 consisting, for example, of a rigid PVC material is secured to the connection piece 44. The guide tube 31 consisting of the same material is attached to the connection piece 46. The connection pieces 47, 45 are connected to storage tubes 48, 49 that also consist of a material with limited flexibility.

The thrust elements 32, 33 are guided between the gear housing 35 and the guide rails 32, 33 in a buckle-resistant fashion with the aid of the two connecting tubes 30, 31 in order to transmit compressive forces. Each thrust element 32, 33 is composed of a flexible, cylindrical core 51 and a helix 52 that surrounds the core 51 and is rigidly connected to the outer circumferential surface of the cylindrical core. The resulting thrust element resembles a flexible rack with a helical gearing that extends around its circumference. The gearing of the gear 36 is adapted to this “rack profile.” The two flexible thrust elements 32, 33 are held in engagement with the gearing of the output gear 36 due to the tangential arrangement of the two through-holes 42, 43.

In carrying out the invention, an end stop sleeve 54, as also depicted in FIG. 3, is crimped onto the thrust element 32. The end stop sleeve 54 consists of a tubular section 55 and a flange or collar 56 that faces the gear housing 35. The size of the connection piece 45 is chosen such that the collar 56 is able to penetrate until it reaches a bottom stop surface 57.

The function of the roller blind is as follows:

In the retracted state, the sheet-like shade 15 is completely wound up on the winding shaft 19. The thrust elements 32, 33 are retracted from the guide rails 16 to such an extent that they are practically no longer connected to or acting upon the guide elements 26. This means that the thrust elements 32, 33 are pushed back into the storage tubes 48, 49 as far as possible. In this state, the working sections, i.e., the sections of the thrust elements 32, 33 that lie between the gear 36 and the corresponding guide element 26, have their shortest length, while the idle sections lying in the storage tubes accordingly have their greatest length.

When the user wishes to pull out or extend the roller blind 14, the motor 36 is actuated in the appropriate direction of rotation by means of an appropriate switch. This causes the gear 36 to be set in rotation. The gear 46 respectively moves the two thrust elements 32, 33 forward in the direction of the guide rails 16 by the same distance, but in opposite directions. This movement takes place in a positive fashion due to the engagement between the helical gearing 52 and the gearing of the gear 36. The movement of both thrust elements 32, 33 is blocked as soon as the flange 56 comes into contact with the end stop surface 57. The positive contact between these two parts blocks the entire drive unit, as well as the motor 36, although the current remains switched on. The movement of the thrust element 33 also stops because the blocking of the thrust element 32 causes the gear 39 to stop.

It will be appreciated that the end stop sleeve 54 can be arranged at such a location on the idle section of one of the thrust elements that the blocking takes place exactly at the location at which the predetermined position of maximum extraction of the roller blind 14 is reached. Accordingly, the blocking is effected without causing any additional pressure to be exerted upon the respective working section of the thrust elements 32, 33. It will be understood that the idle section of the thrust element must have sufficient tensile strength for achieving the desired blocking effect. The flange 56 can be eliminated as long as it is ensured that the tubular part 55 is of sufficient diameter and cannot become jammed in the through-hole 42. The end stop surfaces also must be provided such that wedging cannot occur. The control of the motor vehicle automatically switches off the current supply of the motor after a predetermined period of time that exceeds the expected time required for completely pulling out the sheet-like shade.

The motor may be connected to the on-board voltage of the vehicle with reversed polarity in order to retract the roller blind 14. This causes the thrust elements 32, 33 to be retracted from the guide rails 16. The weaker spring motor 21 winds the sheet-like shade 15 on the winding shaft 19 in accordance with the retraction of the thrust elements 32, 33. A damping element in the form of an elastomeric disk may also be inserted between the end stop sleeve 54 and the bottom surface.

It will be understood that the foregoing arrangement for blocking the movement the thrust elements when reaching an end position is not limited to a rear window application shown as illustrated. The gear arrangement similarly can be utilized in side windows as long as their drive is based on the same principle. If the basic design corresponds to the roller blind design shown in FIG. 2, it also can be used on moonroofs and cargo area covers.

From the foregoing, a roller blind is provided with the pull-out movement of the sheet-like shade being effected with the aid of thrust elements. In order to limit the movement of the thrust element in the respective end position if the drive motor remains switched on, an end stop element seated on at least one of the thrust elements comes into contact with a stationary end stop and blocks further movement.

1. A roller blind for motor vehicles (1) comprising:
a rotatably supported winding shaft (19),
a sheet like shade (15) having one end fixed to said winding shaft (19),
a pull out element (22) connected to an end of said sheet-like shade (15) opposite the winding shaft,
a spring motor (21) coupled to the winding shaft for prestressing the winding shaft (19) in a winding direction of the sheet like shade (15) onto the winding shaft (19),
at least one guide rail for guiding movement of at least one end of the pull-out element (22),
at least one linear thrust element (32) for moving the pull out element (22) away from the winding shaft (19) along the guide rail (16) against the force of the spring motor (21),
a gear motor (34) having a gear housing (35) through which said thrust element (32,33) extends,
said gear motor having an output shaft (37) with a drive gear (39) that cooperates positively with the thrust element (32, 33) and divides the thrust element (32, 33) into a working section that lies between the drive gear (39) and the pull out element (22) and an idle section on an opposite side of the drive gear (39), and
an end stop (54) fixedly connected to the idle section of the thrust element (32, 33) for positively limiting the travel of the thrust element (32,33) to a predetermined amount.

2. The roller blind according to claim 1 including two guide rails for guiding movement of the pull out element (22).

3. The roller blind according to claim 1 including guide rails for guiding movement of opposite ends of said pull out element (22).

4. The roller blind according to claim 1 in which each guide rail (16) defines a guide groove (27) having a cross sectional profile composed of a groove chamber (29) and a groove slot (28) with the width of the groove slot (28) being smaller than the width of the groove chamber (29).

5. The roller blind according to claim 1 in which said guide groove (27) guides movement of the thrust element (32,33) in buckle resistant fashion.

6. The roller blind according to claim 1 in which said thrust element (32, 33) is in the form of a flexible rack having a cylindrical core (51) that extends continuously in a longitudinal direction and at least one helix (52) arranged on the circumference of said core (51).

7. The roller blind according to claim 1 in which said helix (52) has a pitch corresponding to a pitch of said gear (39).

8. The roller blind according to claim 1 in which said gear housing (35) has a through-hole (42,43) through which said thrust element (32,33) extends.

9. The roller blind according to claim 8 in which said through-hole (42,43) corresponds in size substantially to the diameter of said thrust element (32,33) with little play therebetween.

10. The roller blind according to claim 8 in which said housing (35) defines a end stop surface for limiting movement of said end stop (54) through said through hole (42,43).

11. The roller blind according to claim 1 in which said end stop element (54) is a tubular member.

12. The roller blind according to claim 1 in which said end stop element (54) is in the form of a hollow rivet.

13. The roller blind according to claim 1 in which said end stop element (54) is crimped onto said thrust element (32,33).

14. The roller blind according to claim 1 in which said end stop element (54) is in the form of a crimped sleeve.

15. The roller blind according to claim 1 in which said end stop element (54) is injection molded onto the thrust element.
